(19) United States
(12) Patent Application Publication
(10) Pub. No.: US 2011/0206462 A1
(43) Pub. Date: Aug. 25, 2011

(54) HIGH PRESSURE WATER SPRAY PLASTIC PIPE REPLACEMENT APPARATUS AND METHOD

(75) Inventor: GERALD STEVEN SUTTON, Hamilton, OH (US)

(73) Assignee: MR. GERALD STEVEN SUTTON, Hamilton, OH (US)

(21) Appl. No.: 12/709,463

(22) Filed: Feb. 20, 2010

(51) Int. Cl. F16L 55/18

(52) U.S. Cl. 405/184.3

(57) ABSTRACT

An apparatus for replacing underground plastic pipe consisting of a mole, flexible cable, pulling devise and water pump. The mole is a cone shaped tool consisting of a nose section, cutting blades, water nozzles and a hose barb. The flexible cable is inserted through the existing pipe, one end is attached to the pulling devise and the other end is attached to the nose section of the mole. Replacement pipe is attached to the hose barb section of the mole on one end and to the water pump on the other end.

As the pulling devise pulls the mole along the path of the existing pipe, the cutting blades split the existing pipe and water from the nozzles erode and moisten the soil surrounding it. The cone shape of the mole expands the split pipe out into the moistened soil, creating clearance for the new pipe being pulled into place.

### CROSS REFERENCE TO RELATED APPLICATIONS

U.S. Pat. No. 5,544,977 (Cravy, McCall)
U.S. Pat. No. 6,499,912 B2 (Coon)
US Patent Application Publication No. 2003/0223823 A1 (Robinson)

### BACKGROUND OF INVENTION

Plastic pipe has been in use for underground utility applications for many years. In newer homes and businesses plastic pipe has commonly been used for such applications. These pipes may be made for example, from various types of polymers such as polypropylene (PP), high density polyethylene (HDPE), polyvinyl chloride (PVC) or polybutylene (PB). For various reasons these pipes fail, degrade, rupture or are damaged in some manner and need to be replaced. Polymeric pipes made of polybutylene for example are known to fail and need replacement after prolonged contact with chlorinated water. PB pipe was commonly used for water service from 1978 through 1995. Many homes and businesses currently have PB pipe water service lines and need to have this piping replaced. Another common reason for replacing existing underground plastic pipe lines is to increase the size of the line. As businesses grow, for example, water, sewage, or gas usage can increase beyond the capability of existing supply lines.

Many methodologies exist for replacing underground piping. The most common method is to excavate the earth surrounding the pipe, replace the pipe and then place the excavated earth back into the resulting trench. This method can be very costly and results in damage to yards, landscaping, sidewalks, driveways and other structures which must be removed during excavation. Trenchless methods also exist which involve limited excavation, but the equipment used in these methods generate very high forces which are transferred from the equipment into the surrounding environment. As a result these methods can damage existing structures on each end of the pipeline being replaced. To prevent damage to the existing structures such as basement walls, crawl space walls, concrete slab flooring, water meter pits and building foundations an access pit is excavated at one or both ends of the pipeline. The resulting high forces generated by the pipe replacement equipment is then transferred to the earth surrounding the pit and not the existing structure.

Prior apparatus and devises have been proposed for the replacement of existing underground plastic pipe such as those proposed in U.S. Pat. No. 5,544,977 (Cravy, McCall), and U.S. Pat. No. 6,499,912 B2 (Coon). Both of these devises consist of a mole, one or more sharp blades, a winch or similar type pulling devise and a cable. The cable is attached to one end of the mole and replacement pipe is attached to the other. One or more sharp blades are attached to the mole near the cable end. The cable is fished through the existing pipe and one end is attached to the mole, the opposite end is attached to a winch or similar type pulling devise. As the mole is pulled through the pipe, the sharp blades split the existing pipe and the conical section of the mole expands the split pipe outward into the surrounding soil to provide clearance for the replacement pipe to be drawn into position behind the mole. If the split pipe and surrounding soil are not expanded out sufficiently by the mole, the compressive forces exerted Upon the replacement pipe by the surrounding soil can damage the replacement pipe or disconnect it from the mole.

Expansion of the split pipe into the typically hard and compacted soil surrounding the pipe produces extremely high tensile forces in the cable pulling the mole. This cable is pulled by a winch with supporting frame work or a similar type apparatus that can generate the very large forces required. Equipment capable of generating the required force are large, heavy, bulky and expensive. Because of its size and or weight it is impractical to place this equipment in basements, crawl spaces or inside most buildings and homes. The cost of this type of equipment is also much to high to be practical for most businesses replacing small diameter plastic pipe used in residential or commercial applications.

The tooling and methodology described in U.S. Pat. No. 5,544,977 (Cravy, McCall), Polymeric Pipe Splitter, Replacement Tool and Method also incorporates a reciprocating pneumatically operated impact device inside the mole which produces an impact force. This impact force pushes the mole forward which helps split the existing pipe, expand the split pipe over the conical section of the mole and force the split pipe outward into the surrounding soil to provide clearance for the replacement pipe to be drawn into position behind the mole. Because of the size of the impact devise and the size of supply lines to provide compressed air to operate the impact devise this method is not suitable for smaller diameter pipes, where the mole is not large enough to house an adequately sized impact devise or the replacement pipe is not large enough to contain the required supply line to operate the impact devise. Other disadvantages of this method are that it does not adequately address the problems of friction between the prior existing pipe and the replacement pipe, in addition, large forces are generated in the steel cable which pulls the mole and an access pit is required on one or both ends of the pipeline to be replaced.

The tooling and methodology described in U.S. Pat. No. 6,499,912 B2 (Coon), Tool for Replacement of Underground Plastic Pipe has a single blade which scores the pipe inside diameter as it is pulled through the prior existing pipe. As the scored pipe is stretched over the conical section of the mole the stress induced into the pipe by this stretching action splits the pipe at the score. The forces required to split the pipe combined with the force required to expand the split pipe into the soil surrounding the pipe produces extremely high tensile forces in the cable pulling the mole. Disadvantages of this method are that it does not adequately address the problem of friction between the prior existing pipe and the replacement pipe, and large forces are generated in the steel cable which pulls the mole.

US Patent Application Publication No. 2003/0223823 A1 (Robinson), Pipe Replacement Apparatus, consists of a conical shaped tool with a plurality of pipe breaking elements, a plurality of nozzles on the rearward facing edge of the tool, a chain to pull the tool through the pipe and another chain attached on the rearward side of the tool which is used to pull the replacement pipe into position. As the tool is pulled through the prior existing pipe the tool breaks the rigid pipe into small pieces. The nozzles spray water in the rear ward direction to flush the broken pieces of pipe back out of the hole. Disadvantages of this method are that it generates very high forces, is not applicable to non-rigid pipes and is not practical for small diameter pipe. Water spray as used in this method is used to remove the prior existing pipe and does nothing to reduce the forces required to pull the tool through the prior existing pipe.

Many underground plastic pipe lines are made of non rigid polymers which allow the pipe to flex or bend such that when the pipe is installed in the ground it can easily follow a substantially non linear path. This flexible pipe often eliminates the need for additional connectors that would be required if a rigid piping system had been used. This makes installation of flexible pipe lines less time consuming when compared to rigid piping systems and therefore reduces installation labor costs. This is one reason why flexible plastic pipe is often selected for use in applications where a relatively short, non-linear pipe line path is required. As way of example, non-linear or curved pipe line paths are very common in water service pipe lines from the water service meter to a residence or commercial building. In this example the pipeline length is typically less than 100 feet, the elevation of the water meter and the entry point for the pipeline into the building are rarely ever at the identical elevation and rarely ever is the outlet from the municipal water meter pointed directly towards the entry point for the pipeline into the building. As a result, if a rigid piping system is used in this example, additional connectors such as elbows are used to allow the straight rigid pipe line to make numerous direction and elevation changes along the pipeline path.

When replacing prior existing flexible plastic pipe lines prior art methods such as described in U.S. Pat. No. 5,544,977 (Cravy, McCall), and U.S. Pat. No. 6,499,912 B2 (Coon), produce very high tensile forces in the flexible cable used to draw the mole through the prior existing pipe. When the original path of the prior existing plastic pipe has substantial curvature between the start point and end point of the pipeline, high tensile forces in the flexible cable can dislodge the prior existing pipe thereby creating a different path for the replacement pipe that is substantially straighter than the original path. This new path can result in bends in the replacement pipe at either end of the pipeline that exceed the pipe manufacturers specified minimum bend radius for the replacement pipe. Exceeding the manufacturers specified minimum bend radius often results in immediate or premature failure of the newly installed replacement pipe.

None of the prior art methods such as described in U.S. Pat. No. 5,544,977 (Cravy, McCall), and U.S. Pat. No. 6,499,912 B2 (Coon) or US Patent Application Publication No. 2003/0223823 A1 (Robinson), discuss replacing underground plastic pipe lines with substantially larger diameter pipes. If this were attempted with these technologies extremely high forces would be created that would require larger diameter cable or chain than the inside diameter of many smaller diameter pipes. Cable or chain larger in diameter than the inside diameter of the existing pipe could not be fished through the existing pipe. The extremely high tensile forces required with these methods are not practical for many applications for the various reasons discussed earlier.

The method and apparatus which is the subject of this patent can be used to replace existing underground plastic pipe lines with substantially larger diameter pipes without excessively large forces. In fact, the method and apparatus described in this patent will produce very low forces in the pulling cable such that a simple low cost pulling devise can be used. This is accomplished by a plurality of spray nozzles spaced out at a large enough diameter to erode the earth adequately in front of the replacement pipe to reduce the force to expand the prior existing pipe into the surrounding soil and allow room for replacement pipe to be drawn into position in a non-binding manner, to a very small fraction of the force generated by other trenchless methods.

When using trenchless methods to replace prior existing rigid underground pipes an access excavation is almost always required on at least one end of the pipe line and typically both. With rigid pipes an access excavation is typically needed on one end of the pipe line to be replaced that is slightly longer than one pipe length to provide access to join sections of replacement pipe as they are pulled or pushed into position. On the opposite end of the rigid pipe line to be replaced an access excavation is typically needed to join the end of the replacement pipes to the remaining piping system and/or to position a pulling devise used to pull the new replacement pipes into position.

The method and apparatus which is the subject of this patent can be used to replace prior existing, rigid, underground pipe lines where any type pipe which can readily be split by a sharp tool has been used. The advantages of this invention are that existing pipes can be replaced with smaller diameter, similar diameter or substantially larger diameter pipes without excessively large forces. In fact, the method and apparatus described in this patent will produce very low forces in the pulling cable such that a simple low cost pulling devise can be used. This is accomplished by a plurality of spray nozzles spaced out at a large enough diameter to erode the earth adequately in front of the replacement pipe to reduce the force to expand the prior existing pipe into the surrounding soil and allow room for replacement pipe to be drawn into position in a non-binding manner, to a very small fraction of the force generated by other trenchless methods.

Another advantage of this method is that small diameter, rigid, prior existing pipes which can readily be split by a sharp tool can be replaced that could not be replaced with other trenchless methods. The forces generated in the pulling cable which is the subject of this patent are small. Due to the greatly reduced pulling forces, much smaller diameter pulling cable can be used. Other methods that generate very high forces are not practical for small diameter pipe applications because the size of the cable or chain which is required, is too large to be fished through the prior existing pipe.

### SUMMARY OF INVENTION

A tool for replacing polymeric underground plastic pipe or any type pipe which can readily be split by a sharp tool. This tool can be used to replace existing pipes with similar, smaller or substantially larger diameter replacement pipe. In applications where the prior existing pipes follow a curved path, the replacement pipe can be made of any material such as plastic or copper but must be flexible or readily bendable. In applications where the prior existing pipes follow a substantially straight line, the replacement pipe can be made of any material and can be flexible or rigid. The tool consists of a nose section on the forward end of the tool which is smaller in diameter than the inside diameter of the prior existing pipe, one or more knife blades which are attached to the nose section, an expansion cone section with high pressure water nozzles placed inline with the knives and a hose barb on the rearward end of the tool.

The tool is pulled through the prior existing pipe by way of a flexible cable attached to a winch, come along or other pulling devise. The flexible cable attaches to the nose section of the tool and the replacement pipe attaches to the opposite end of the tool. The shape of the nose section allows it to be pulled through bends in the buried pipe and remain substantially centered inside the prior existing pipe. The knife blades split the pipe as the tool is pulled through the prior existing pipe. The cone section expands the prior existing pipe out and into the surrounding soil to allow room for the replacement pipe to be pulled into place in a nonbinding manner. High pressure water exits the nozzles on the main body of the tool in a substantially forward direction which erodes the earth surrounding the prior existing pipe upstream Of the expansion cone section of the tool. Eroding the earth surrounding the prior existing pipe in this manner greatly reduces the forces required to expand the prior existing pipe into the otherwise hard and compacted surrounding soil

The high pressure water also creates an earth and water slurry which flushes back across the previously split prior existing pipe and the replacement pipe. This greatly reduces the friction forces on the replacement pipe as it is pulled into place. The earth and water slurry also provides lubrication for removal of the split pieces of prior existing pipe. In most cases, removal of the prior existing split pieces of pipe can be accomplished by hand and without the aid of powered machinery.

### BRIEF DESCRIPTION OF DRAWINGS

FIG. 1 is an isometric view of the pipe replacement tool which is also referred to as the mole.

FIG. 2 is a sectional view of the entire system with the pipe replacement tool being pulled through flexible, prior existing pipe.

FIG. 3 is a partial sectional view of the pipe replacement tool pulling replacement pipe which is similar in diameter to the prior existing pipe.

FIG. 4 is a partial sectional view of the pipe replacement tool pulling replacement pipe which is substantially larger in diameter than the prior existing pipe.

FIG. 5 is a sectional view of the entire system with the pipe replacement tool being pulled through rigid, prior existing pipe and pulling rigid replacement pipe which is substantially larger in diameter than the prior existing pipe.

### DETAILED DESCRIPTION OF THE INVENTION

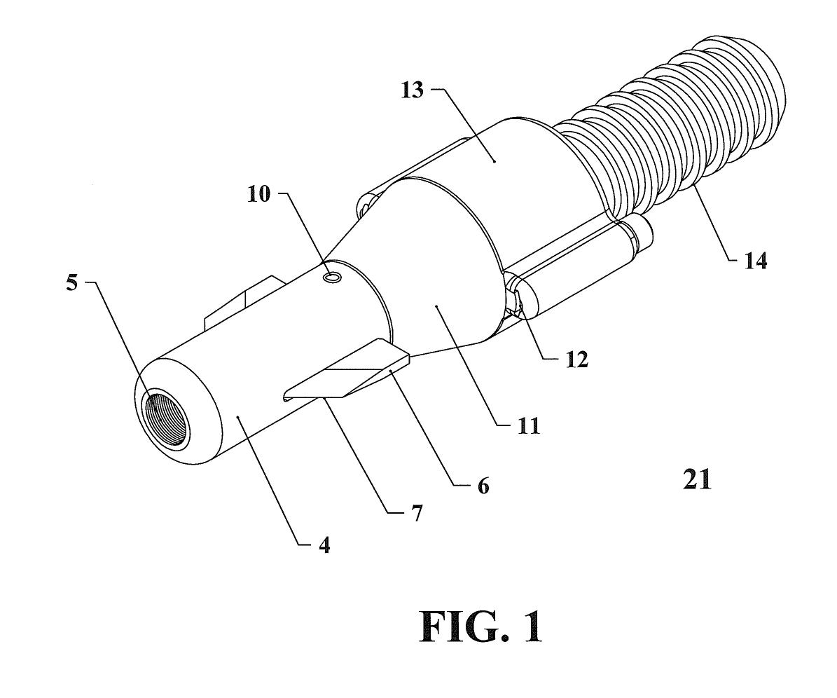

The plastic pipe replacement tool which is also referred to as the mole 21 is made of metal such as stainless steel and consists of as a nose section 4, expansion cone section 11, hose barb section 14, nozzles 12 and cutting blades 6 as shown in FIG. 1.

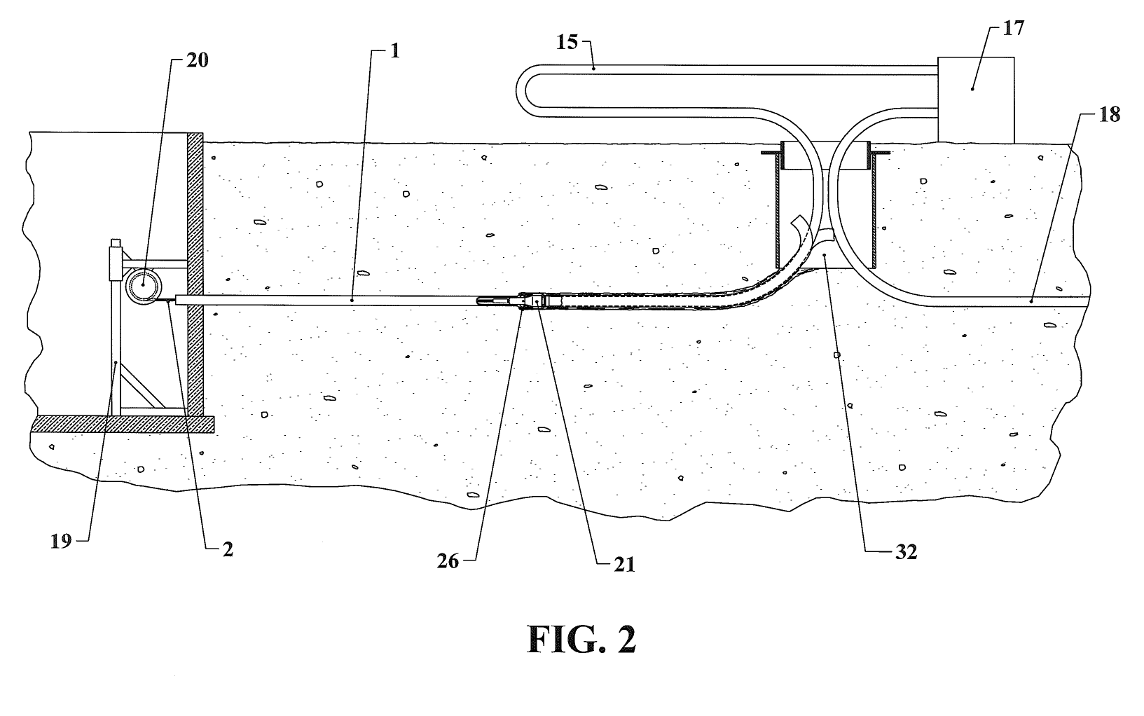

FIG. 2 of this embodiment is a general overview of the system where the mole along with the replacement pipe are pulled through the prior existing pipe from the upstream end of the pipe to be replaced toward the downstream end of the pipe to be replaced. On the upstream end of the pipe to be replaced are the water source 18, the high pressure water pump 17 and one end of the replacement pipe 15. The opposite end of the replacement pipe 15 is attached to the mole 21 at the hose barb section 14 which is on the upstream end of the mole. On the downstream end of the pipe to be replaced is the pulling devise 20 along with one end of the cable 2. The opposite end of the cable 2 is attached to the mole 21 at the nose section 4 which is on the downstream end of the mole.

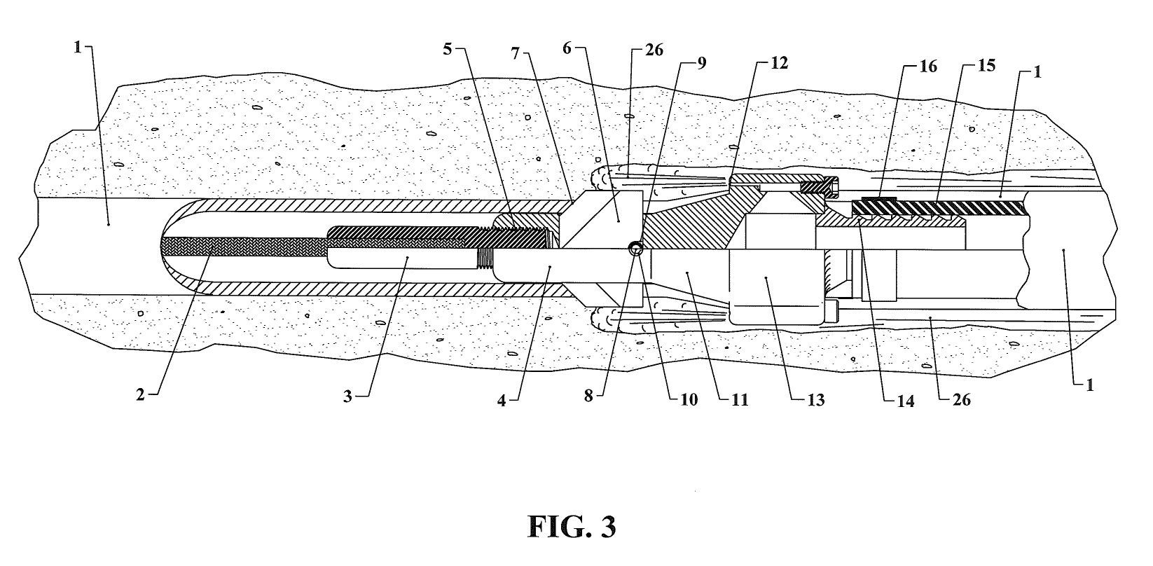

FIG. 3 provides greater detail of the replacement tool, its various components and the method of operation. In FIG. 3 the flexible cable 2 is inserted through the prior existing underground plastic pipe 1 and is attached to nose section 4 of the mole 21 by way of a threaded stud 3 which is swaged to the end of the cable 2. The threaded stud 3 is inserted into a mating threaded hole 5 in the nose section 4 of the mole 21. Blade 6 of FIG. 3 is held in position by a split pin 10 which is inserted through a hole 8 in the nose piece 4. The hole 8 in the nose piece 4 is aligned with a slot 9 in the blade 6. The blade 6 is then constrained and trapped in position by the split pin 10 and the slot 27 in the mole 21. High pressure water is supplied to the mole by way of the replacement pipe 15 which is attached to the mole by clamping the replacement pipe to the hose barb 14 with a ring clamp 16 that is compressed around the replacement pipe as shown in FIG. 3.

The cutting blades 6 are located on the nose piece section 4 and are forward of the expansion cone section 11 of the mole and positioned so as to split the prior existing pipe 1 prior to expanding the prior existing pipe 1 over the expansion cone section 11 of the mole 21. As the mole is drawn through the prior existing pipe 1 by the flexible cable 2, high pressure water exits the mole 21 through one or more nozzles 12 pointed in the downstream direction. The high pressure water exiting the nozzles 12 erodes the soil surrounding the prior existing pipe 1 and flushes the earth and water slurry 26 back over the replacement pipe 15. Eroding the soil surrounding the prior existing pipe 1 in front of the expansion cone section 11 of the mole 21 as the mole is drawn through the pipe 1 by the flexible cable 2 greatly reduces the forces required to expand the split sections of the prior existing pipe out and into the surrounding soil. The split sections of the prior existing pipe 1 must be expanded out into the surrounding soil to provide adequate room for the replacement pipe 15 to be drawn into place behind the mole 21 in a non-binding manner.

In the preferred embodiment as shown in FIG. 3, the blade 6 is in line with the nozzle 12 such that the when the prior existing pipe 1 is split by the sharp edge of the blade 7 and is expanded over the expansion cone section 11 of the mole 21 the split section of prior existing pipe is moved away from the nozzle and thereby provides a clear path for the high pressure water exiting the nozzle 12 to erode the surrounding soil.

The earth and water slurry 26 created by the high pressure water used to erode the soil, lubricates the replacement pipe 15 as it is drawn along the path of the prior existing pipe 1. This reduces friction forces exerted on the replacement pipe 15 as it is drawn into position by the pipe replacement apparatus. The earth and water slurry 26 also provides lubrication for removing the split sections of prior existing pipe 1 after the prior existing pipe has been split along its entire length.

In FIG. 3 the nose section 4 of the mole 21 is smaller in diameter than the inside diameter of the prior existing pipe 1 which is to be replaced. The nose section 4 contacts the inside surface of the prior existing pipe 1 forcing the mole to follow the path of the prior existing pipe as it is drawn through the prior existing pipe by the flexible cable 2. The short length of the mole 21 in combination with the design of the nose section 4, allow it to follow bends in the path of the prior existing pipe

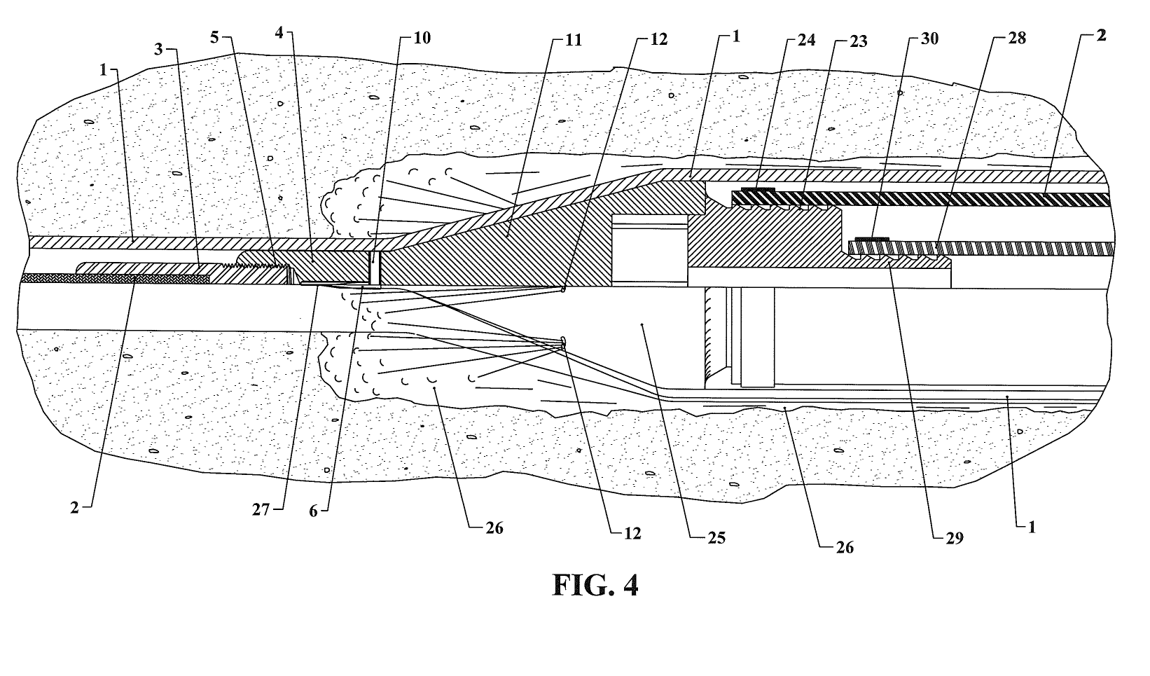

FIG. 4 illustrates an alternative mole configuration 25 which can be used to replace prior existing pipe 15 with significantly larger replacement pipe 22. Mole configuration 25 has all the features of mole 21 and one additional feature, an attachment sleeve 23. The attachment sleeve 23 is where the replacement pipe 22 is attached to the upstream end of the mole by way of a compressible clamping ring 24. High pressure water is supplied to the mole by way of the high pressure supply line 28, which attaches to the hose barb 29 on the upstream end of the mole. The supply line 28 is held in position on the hose barb 29 by the compressible clamping ring 30.

Because larger diameter pipes are not always rated for the water pressure required to erode the soil surrounding the prior existing pipe a separate supply line of a smaller diameter and higher pressure rating may be required. The amount of water pressure needed depends on the soil conditions and can vary greatly from one location to another. In general, the pressure rating for any high pressure water supply line used to erode soil as discussed here should be at least 200 psi continuous use. Water pressure much lower than 200 psi can be effective but this is rare and again is highly dependent on soil conditions.

FIG. 4 also illustrates the number of nozzles 12 needed to effectively erode the surrounding soil to allow room for the replacement pipe to be pulled into place, increases as the size of the replacement pipe increases. For small diameter pipe such as ¾ inch which is illustrated in FIG. 3, using only two nozzles can be very effective. For 2″ diameter replacement pipe such as shown in FIG. 4, four or more nozzles may be needed. Another aspect of this invention illustrated in FIG. 4 is that the diameter of the main body of the mole 13 needs to be slightly larger than the outside diameter of the replacement pipe. This is needed to protect the leading edge of the replacement pipe 22 from damage or being dislodged from the mole 25 by the surrounding soil which may contain rocks or other objects.

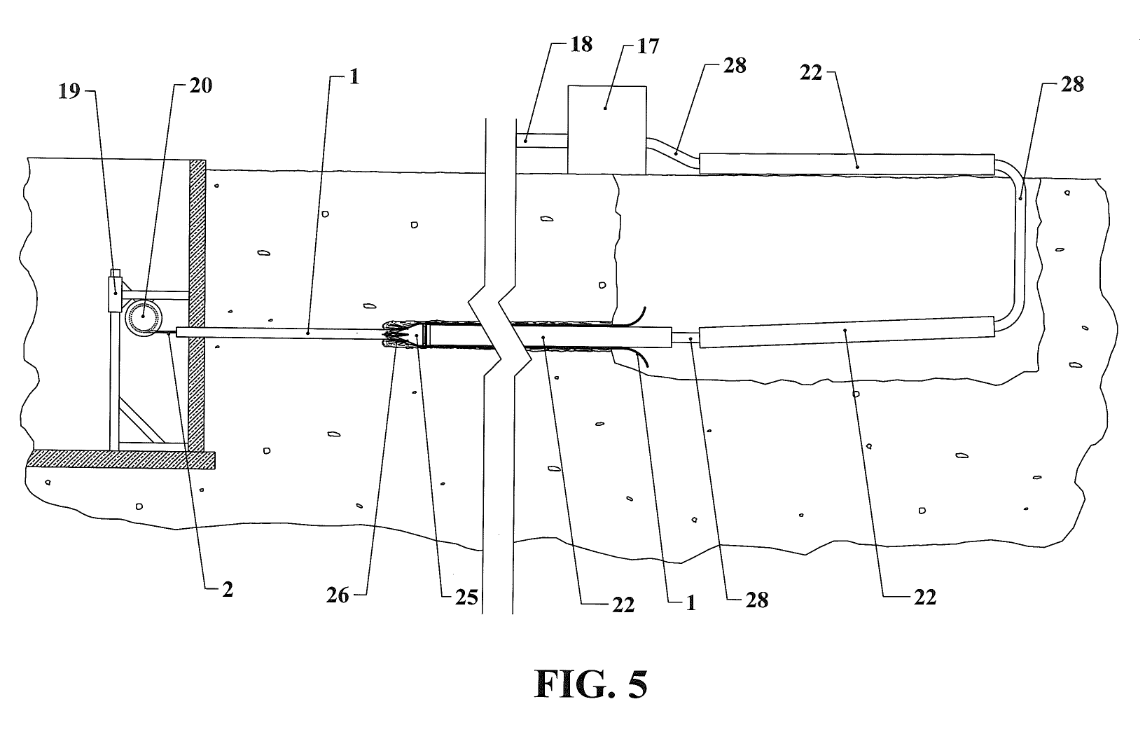

FIG. 5 illustrates how this invention can be used with rigid pipes. When rigid pipes are to be replaced an excavation is needed at one end of the pipe to be replaced, and often both ends depending on the specific conditions. In the embodiment shown here only one excavation is required because the downstream end of the pipe to be replaced is located in a basement, similarly as was illustrated in FIG. 2 for flexible pipe replacement. The excavation must be long enough for a full length of replacement pipe to be inserted in the excavation and deep enough to readily access the end of the pipe to join additional sections of the replacement pipe as needed. The preferred embodiment for rigid pipes uses a mole 25 with a separate high pressure supply line 28. The replacement pipe 31 is attached to the mole 25 at the attachment sleeve 23. The sections of replacement pipe 31 are staged on the ground near the upstream excavation. The supply line 28 is fished through all the required replacement pipes 31 and one end is attached to the mole 25 and the other end is attached to the high pressure pump 17. As each section of replacement pipe 31 is pulled into position, the next section of replacement pipe is brought into the excavation and is joined to the previous section. This repeats until all replacement pipe sections 31 have been pulled into position and the final connections can be made on both ends. The high pressure supply line 28 is removed from the replacement pipes 31 prior to making the final connections on each end of the replacement pipe line.

With the method described in FIG. 5 any material may be used for the replacement pipe. Steel, copper and plastic are several options for replacement pipe. The replacement pipe may be smaller in diameter, similar in diameter or significantly larger in diameter than the prior existing pipe 32. The replacement pipe as shown in FIG. 5 is rigid. The prior existing pipe 32 shown in FIG. 5 is rigid and significantly smaller in diameter than the replacement pipe 31. The prior existing pipe to be replaced 32 may be rigid or flexible but must be capable of being split by a sharp edged tool.

1. A tool for replacing prior existing underground plastic pipe with a pipe of approximately the same interior diameter, consisting of a nose section smaller in diameter than the interior diameter of the prior existing underground plastic pipe; a means for attaching a pulling cable; a means for attaching a replacement pipe; a means for attaching one or more cutting blades; a cylindrical main body section; a means of providing high pressure water and one or more high pressure water nozzles.

2. A tool according to claim 1 wherein the replacement pipe has a smaller interior diameter than the prior existing pipe.

3. A tool according to claim 1 wherein the replacement pipe has a significantly larger interior diameter than the prior existing pipe.

4. A tool according to claims 1, 2 and 3 wherein the maximum diameter of the tool is slightly greater than the outside diameter of the replacement pipe hereto attached.

5. A tool according to claims 1, 2, 3 and 4 wherein the forward portion the cylindrical body of the tool adjacent to the nose section is tapered.

6. A tool according to claims 1, 2, 3, 4 and 5 wherein high pressure water is supplied to the high pressure water nozzles by way of the replacement pipe.

7. A tool according to claims 1, 2, 3, 4 and 5 wherein high pressure water is supplied to the high pressure water nozzles by way of a separate high pressure water line.
